(19) United States
(12) Patent Application Publication
(10) Pub. No.: US 2012/0313531 A1
(43) Pub. Date: Dec. 13, 2012

(54) SOLAR LIGHTING RADIO COMMUNICATION METHOD AND APPARATUS

(75) Inventor: David James Macleod, Burnaby (CA)

(73) Assignee: CARMANAH TECHNOLOGIES CORP., Victoria, BC (CA)

(21) Appl. No.: 13/581,337

(22) PCT Filed: Aug. 25, 2010
(86) PCT No.: PCT/CA2010/001323

§ 371 Date: Aug. 27, 2012

(30) Foreign Application Priority Data
Mar. 15, 2010 (CA) 2,696,542

(51) Int. Cl. H05B 37/02

(52) U.S. Cl. 315/149

(57) ABSTRACT

A solar-powered light assembly that communicates by radio with other assemblies is configured such that its radio is operable, in either a long period sleep mode or a short period sleep mode. When in the short period sleep mode, a network of light assemblies can collectively react relatively quickly to motion detection at one assembly. The long sleep period mode allows for conservation of power at times when the system is not intended to be responsive to motion detection.

### FIELD OF THE INVENTION

This invention relates to a method for reducing power consumption in a network of solar powered lights that are in radio communication with one another.

### BACKGROUND OF THE INVENTION

A solar powered network of lights can be used to provide lighting to areas which do not have access to grid power or where the power is intermittent or unreliable. Many parks, parking lots and roadways benefit from using solar powered lighting. A solar powered light uses the sun's energy during the day to charge a battery which powers the lights by night.

A primary concern in solar powered lighting applications is the amount of energy the system uses. A finite amount energy can be stored in a battery for a given location and a given size of solar panels and such energy must be sufficient to power the light when needed. Various methods are used to conserve power. One method is to have lighting profiles that turn the light on for a predetermined period of time (for example, for a specific number of hours after dusk) and then dim the light or turn it off when the need for bright lighting is reduced.

Another method to conserve power is to connect the lighting system to react to sensors associated with the lights. The sensors are typically motion sensors, but may also be other types of sensors such as induction sensors of the type used to detect the presence of a vehicle on a roadway. Making the light responsive to a sensor allows the light to be maintained in a dim or off state most of the time but to illuminate more fully for a period of time when a sensor event (such as movement in the immediate vicinity) is detected.

In a network of lights in radio communication with one another, a light that is activated to brighten in reaction to a sensor may signal the other lights, for example within a certain radius, to also brighten for a period of time before returning to the quiescent state.

The radios associated with each light in the network spend a significant amount of time not doing anything. Such radios have three modes of operation: sleep mode, receive mode and transmit mode. Each of the three modes draws a different current. In sleep mode, the transmitter and receiver are both off and the radio does not respond to any incoming commands, drawing less than 1 μA. In receive mode, a typical radio may draw about 50 mA while in transmit mode it may draw over 200 mA.

Since in a solar powered lighting system, it is desirable to have the radio consume as little power as possible, in many systems the radios periodically enter into extended sleep (off) cycles (for example 9 seconds) and then synchronously change to receive mode for a short period (e.g. 1 second) before returning to the sleep mode. Such cycle may be interrupted to allow the radio to enter into transmit mode when required.

The current consumption of the described example is as follows:
Sleep mode: 9 seconds at 0.001 mA
Receive mode: 1 second at 50 mA
Average current: −5.1 mA

The average current is sensitive to the period of the sleep mode. For example, if the sleep mode is reduced to 5 seconds, the average current increases to 8.4 mA.

Reducing the average current consumption by increasing the sleep time comes at a price. By making the sleep time longer, the time it can take to signal the other lights (for example, to cause them to brighten in response to detected motion at the signalling light) is also longer. The signalling light must wait for the lights to exit the sleep mode and enter the receive mode before the command can be sent and received by them. In current system design, a balance must therefore be struck between how much current the system uses and how quickly the other lights can respond to asynchronous events.

It is therefore an object of this invention to provide an easier trade-off between power consumption and response time for a solar powered network of lights in radio communication.

This and other objects of the invention will be better understood by reference to the detailed description of the preferred embodiment which follows. Note that not all of the objects are necessarily met by all embodiments of the invention described below or by the invention defined by each of the claims.

### SUMMARY OF THE INVENTION

A solar powered network of lights in radio communication with one another is adapted to operate in at least a long sleep time mode for when the system is not intended to react to sensor events and a shorter sleep time mode for when the system is reactive to sensor events. By providing two different sleep time modes, the current savings of a long sleep time are achieved but a suitably fast response time is also available. Suitable means are provided to control the operation of the radio as between the longer sleep time mode and the shorter sleep time mode according to predetermined parameters.

The appropriate mode may be selected based on the time of day or it may be selected based on detection of an asynchronous event (such as the onset of dusk or dawn).

In a preferred embodiment, the predetermined long or short sleep time period and/or the period during which the radio will remain in a given mode is configurable by a user through a user interface of at least one of the light assemblies in the network. The user may also program the assembly in terms of the desired period in which the network is to be in sensor reactive mode (using a short radio sleep period).

In one aspect, the invention is a method for operating a plurality of solar powered lighting assemblies in which a motion sensor is in communication with at least one of the assemblies. Each assembly has a radio for communicating with the other assemblies that is configured to cycle periodically between a sleep mode and a receive mode for synchronous communication with them. The assemblies maintain a record of a first radio sleep period or a shorter second radio sleep period. A transition in the operation of the radio in the assemblies as between the first and second sleep periods is responsive on a substantially daily basis to one or more parameters selected from among the group of parameters comprising a preset time, a transition between day and dusk, a transition between night and dawn and an elapsed time in relation to the occurrence of one of the other parameters of the group.

While the radio is operating using the short sleep period, the light in the assembly that is in communication with the motion sensor turns on or brightens in response to the detection of motion by the motion sensor, and signals at least one other light assembly in the network causing its light to also turn on or brighten.

The transition between long and short sleep period modes may be caused by a controller that dispatches a command by radio to the lighting assemblies of the network.

In another aspect, the invention comprises a solar powered light assembly comprising a solar panel, a light, a processor and a radio for communicating with like assemblies. The radio is configured to cycle periodically between a sleep mode and a receive mode for synchronous communication with the other assemblies. The radio is selectively operable with a first sleep period or a shorter second sleep period. The processor is configured to cause said radio to selectively operate using the first sleep period or using the second sleep period according to one or more predetermined parameters selected from among the group of parameters comprising the occurrence of a predetermined time of day or night, the occurrence of a transition from day to dusk, the occurrence of a transition from night to dawn, an elapsed time from one of the other parameters of the group, a command received from an external device.

The predetermined time is derived from a record maintained by said assembly.

In another aspect, the occurrence of the one or more parameters may be communicated to the assembly by a controller.

In a preferred embodiment, the processor is configured to cause the radio to begin operating with the second sleep period for a predetermined period and to be operated with the first sleep period after the predetermined period has elapsed or occurred.

The foregoing was intended as a broad summary only and of only some of the aspects of the invention. It was not intended to define the limits or requirements of the invention and therefore the claims may include aspects not specifically identified in this section. Other aspects of the invention will be appreciated by reference to the detailed description of the preferred embodiment and to the claims.

### BRIEF DESCRIPTION OF THE DRAWINGS

The invention will be described by reference to the detailed description of the preferred embodiment and to the drawings thereof in which:

FIG. 1 shows a network of solar powered lights according to the preferred embodiment;

FIG. 2 is a diagrammatic representation of the components of a light assembly according to the preferred embodiment;

FIG. 3 is a flowchart of the steps in a controller-actuated command to light assemblies in a network to transition to fast sleep mode; and,

FIG. 4 is a timing diagram showing radio cycles involving slow and fast sleep periods according to the preferred embodiment.

### DETAILED DESCRIPTION OF THE PREFERRED EMBODIMENT

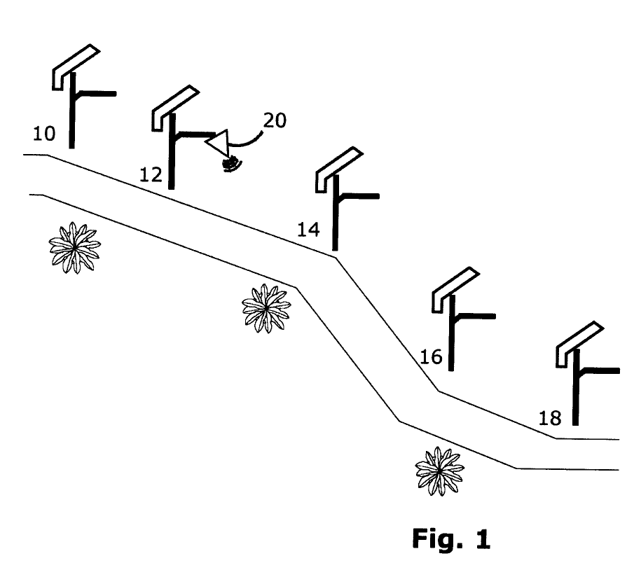

FIG. 1 represents an exemplary configuration of a network of solar powered light assemblies wherein the assemblies 10, 12, 14, 16 and 18 are in radio communication with one another for the purposes of coordinating their operation. One of the assemblies (10 in this case) may be designated, either permanently or temporarily, as a controller to ensure uniform operation of the various members of the network, for network diagnostic purposes and for other purposes not directly related to the present invention. A motion sensor 20 is in communication with at least one member 12 of the network to signal member 12 upon detecting motion.

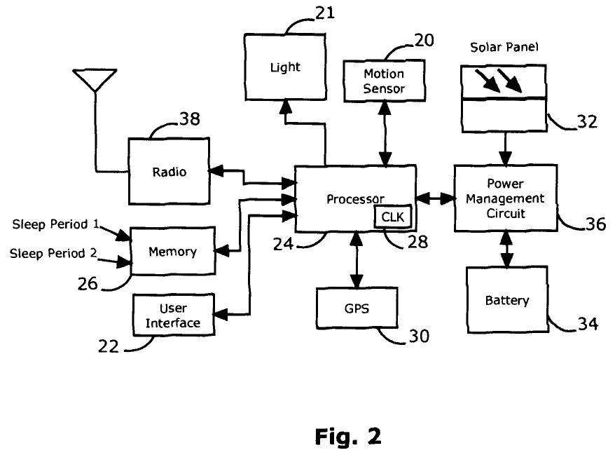

Referring to FIG. 2, each light assembly comprises a light 21, a user interface 22, a processor 24, flash memory 26, a clock 28 (which may be internal to the processor 24) and a GPS module 30. A suitable processor is Texas Instruments microprocessor MSP430-5438.

The lighting assembly also comprises a solar panel 32, a 12V or 24V battery 34 and a power management circuit 36 (which may be integrated into the processor functions).

Each light assembly 10, 12, 14, 16 and 18 also includes a radio 38 capable of transmitting and receiving signals from the other lights in the network and to cycle periodically between sleep and receive modes for synchronously communicating with the radios of the other assemblies. The radio 38 is selectively operable using one of at least two different sleep periods for the sleep mode. A suitable radio is a Digi 2.4 GHz Mesh Radio.

In some cases, communication between the various light assemblies may be according to a daisy chain model in which each light assembly communicates with only a limited number of other light assemblies that are most near to it, with an appropriate forwarding protocol to ensure that all light assemblies in the network eventually receive the same network commands.

Once configured, the light assembly maintains a record in memory 26 of the period of a long radio sleep time and of the period of a short radio sleep time, as well as of the period of time during which the radio 38 is intended to remain in a given mode of operation (using the long or the short sleep time). Clock 28 is used to provide a reference real time and a timer for implementing the intended periods and processor 24 periodically causes the GPS module 30 to acquire a UTC reference time for the purpose of synchronizing clock 28.

Processor 24 is configured to cause radio 38 to selectively operate using the long sleep time or the short sleep time recorded in memory 26.

In the preferred embodiment, when configuring the lighting assembly, the user is prompted by user interface 22 to indicate the substantially daily period of time of day or night (probably the latter) during which the light is expected to be in sensor reactive mode. That daily period of time may be based on a fixed clock time, such as from 11 PM to 2 AM, or it may be based on an asynchronous event such the onset of dusk. A combination is also used, such as predetermining that the sensor reactive mode will be enabled beginning 4 hours after dusk is detected until 7 hours after dusk was detected. The detection of an asynchronous event such as the onset of dusk or dawn may be done using a light level sensor or by measuring the solar power being collected by the solar panel 34. In an alternative embodiment the period of time during which the light is expected to be in sensor reactive mode is preset at the factory by reference to customer specifications.

The specified period of time for the sensor reactive mode is recorded in memory 26 as the period of time during which the radio is to operate in according to the short sleep period, allowing the lighting elements to communicate with one another relatively quickly upon the occurrence of a motion sensor event.

When the radio is not in short sleep period mode, it defaults to the long sleep period mode. The detection of the onset of dawn may also be used as a parameter to trigger a transition from a short sleep period to a long sleep period. This assumes that the light assembly was in a short sleep period immediately before dawn, such as would be the case if the light assembly is in motion sensor reactive mode until dawn.

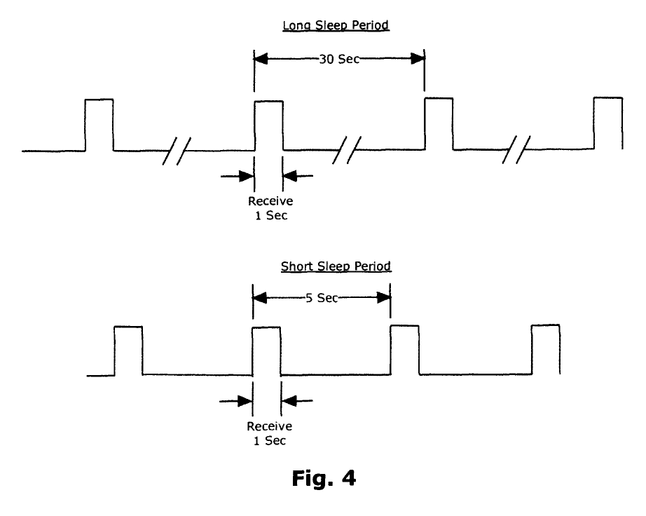

In the preferred implementation illustrated in FIG. 4, the following parameters are used:
Transmit period: 0.003 seconds at 200 mA
Receive period: 1 second at 50 mA
Long sleep period: 30 seconds at 0.001 mA
Short sleep period: 5 seconds at 0.001 mA.

In the example given in the Background section of this disclosure, a sleep time of 5 seconds at 0.001 mA with a receive mode time of 1 second at 50 mA yielded an average current of 8.4 mA. By choosing a 30 second long sleep time for when the lights are either not on or are fully on, and a 5 second sleep time for when the lights are reactive to motion sensor events, the average current would be about 8.4 mA for the short sleep time mode and 1.6 mA for the long second sleep time mode. If the network were configured to be in motion sensor reactive mode for 5 hours every day, the average daily current of the radio would be only 3 mA.

It is contemplated that the processors will cause the radios of the network to operate in long sleep time mode both during the day when lights are not needed (but when various other communication functions may be undertaken) and during times when full lighting is required in any event, for example during evening hours when heavy traffic is expected. During such times, motion sensors are typically deactivated.

Later in the evening and through the night, a user may wish to have the lights of the network very dim or off, but to have the capacity to brighten for a limited time when motion is detected. During such times, the motion sensors are activated. In the event that motion is detected adjacent one of the lights, the sensor 20 signals the lighting assembly 12 with which it is in contact. Processor 24 receives the input from the motion sensor 20 and causes its light 21 to brighten. Processor 24 also determines where in the sleep-receive cycle the radios 38 of the network are, and when they are scheduled to enter the receive mode, radio 38 of lighting assembly 12 is directed to enter the transmit mode and to signal the other assemblies (or those within certain location parameters such as within a given radius) to brighten their lights 21. As the radios would then be using a short sleep time, the period of time during which the processor must wait to transmit the brighten signal is relatively short and the system is relatively responsive to the event.

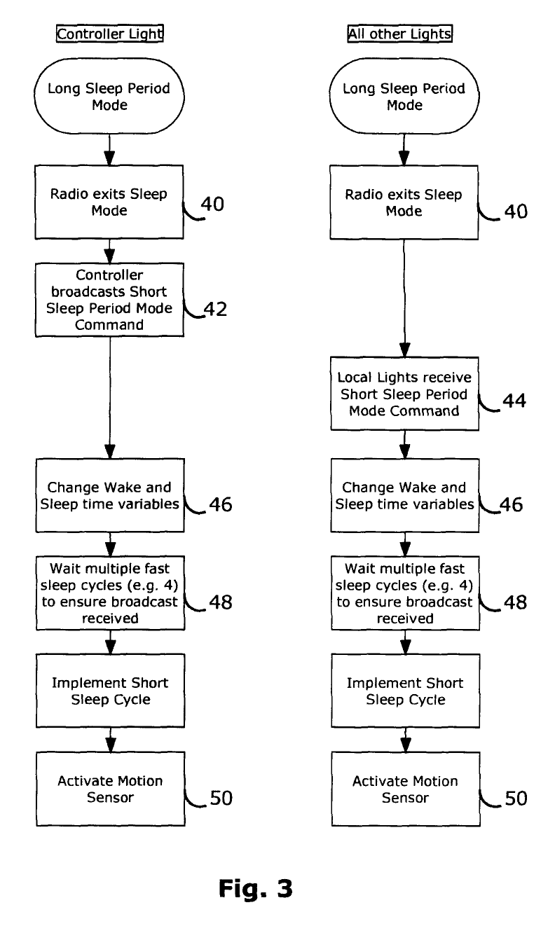

In the preferred embodiment, all lighting assemblies of the network operate independently to switch between sleep time modes according to the predetermined parameters discussed above. However, it is contemplated that the switch over can be coordinated by controller lighting assembly 10 that can dispatch a command to the other assemblies to effect a transition in modes at the appropriate time or to signal the occurrence of the predetermined trigger parameter. FIG. 3 illustrates the steps involved from the point of view of the controller 10 and the other lighting assemblies. The command from the controller assembly is for the lights to transition from a slow sleep mode (long sleep time) to a fast sleep mode. Upon the lights synchronously exiting the sleep mode and entering the receive mode (40), the controller radio broadcasts (42) a fast sleep mode command that is received (44) by the other lights. The dispatch and receipt of the command is interpreted by the processors which then record and update (46) the parameters of operation so as to apply the short sleep period. The parameters may also include the period of time during which the short sleep period mode will be effective or alternatively the period of time may be indefinite until the controller orders a transition back to the long sleep period mode. In the illustrated embodiment, the network is configured to await (48) a predetermined number of sleep- receive cycles to ensure that all lights in the network have received the transition command. Once the cycles have elapsed, the new sleep mode is implemented. Implementation of the fast sleep mode may conveniently be tied to activation of the motion sensors associated with the individual lights (50).

The invention offers both the responsiveness needed to allow the network of lights to operate in sensor reactive mode, while also offering considerable energy savings for the lighting assemblies of the network.

It will be appreciated by those skilled in the art that the preferred and alternative embodiments have been described in some detail but that certain modifications may be practiced without departing from the principles of the invention.

1. A method for operating a plurality of solar powered lighting assemblies, at least one motion sensor being in communication with at least one of said assemblies, each of said assemblies comprising a solar panel, a light, a radio for communicating with others of said assemblies and being configured to cycle periodically between a sleep mode and a receive mode for synchronous communication with said other assemblies and a record of a first radio sleep period or a second radio sleep period shorter than said first sleep period, said method comprising:
causing a transition in the operation of said radio in said assemblies as between said first and second sleep periods responsive on a substantially daily basis to one or more parameters selected from among the group of parameters comprising a preset time, a transition between day and dusk, a transition between night and dawn and an elapsed time in relation to the occurrence of one of the other parameters of the group.

2. The method of claim 1 wherein each of said lighting assemblies further comprises a user interface and said preset time is programmed in at least one of said lighting assemblies by a user of said assembly.

3. The method of claim 1 wherein each of said lighting assemblies further comprises a user interface and said elapsed time is programmed in at least one of said lighting assemblies by a user of said assembly.

4. The method of claim 3 or 4 further comprising the step of a user programming at least one of said lighting assemblies for operation in a motion sensor reactive mode for a predetermined period.

5. The method of claim 1 further comprising the step of, in response to the detection of motion by said motion sensor when said radio is operating using said short sleep period, causing said light to turn on or brighten in at least said assembly that is in communication with said motion sensor and in at least one other lighting assembly.

6. The method of claim 5 wherein said step of causing a transition is performed by a controller dispatching a command by radio to said lighting assemblies.

7. A solar powered light assembly comprising a solar panel, a light, a processor and a radio for communicating with like assemblies, said radio being configured to cycle periodically between a sleep mode and a receive mode for synchronous communication with said like assemblies, wherein:
said radio is selectively operable with a first sleep period or a second sleep period that is shorter than said first sleep period; and,
said processor is configured to cause said radio to selectively operate using said first sleep period or using said second sleep period according to one or more predetermined parameters selected from among the group of parameters comprising the occurrence of a predetermined time of day or night, the occurrence of a transition from day to dusk, the occurrence of a transition from night to dawn, an elapsed time from one of the other parameters of the group, a command received from an external device.

8. The assembly of claim 7 wherein said predetermined time is derived from a record maintained by said assembly.

9. The assembly of claim 7 wherein the occurrence of said one or more parameters is communicated to said assembly by a controller.

10. The assembly of claim 8 wherein said processor is configured to cause said radio to begin operating with said second sleep period for a predetermined period and to be operated with said first sleep period after said predetermined period.

11. The assembly of claim 7, 8, 9 or 10 wherein said light turns on or brightens in response to a radio communication that motion has been detected by a motion sensor while said radio is operating using said second sleep period.

12. The assembly of claim 7 wherein said assembly further comprises a user interface and said predetermined time is user programmable.

13. The assembly of claim 7 wherein assembly further comprises a user interface and said elapsed time is user programmable.

14. A network of a plurality of lighting assemblies, each lighting assembly being as recited in claim 7, said network further comprising at least one motion sensor in communication with at least one of said lighting assemblies, and said network being configured to operate such that, in response to motion being detected by said motion sensor while said radio in each of said plurality of lighting assemblies is operating using said second sleep period, said light in said assembly that is in communication with said motion sensor turns on or brightens, and at least one other of said lighting assemblies receives a radio communication during said receive mode to signal its light to also turn on or brighten.
